(19) United States
(12) Patent Application Publication
(10) Pub. No.: US 2016/0279879 A1
(43) Pub. Date: Sep. 29, 2016

(54) THREE DIMENSIONAL PRINTING METHOD AND THREE DIMENSIONAL PRINTER ADOPTING THE SAME

(71) Applicants: Inventec Appliances (Pudong) Corporation, Shanghai (CN); Inventec Appliances Corp., New Taipei City (TW); Inventec Appliances (Shanghai) Co., Ltd., Shanghai (CN)

(72) Inventors: Yong-Ping ZHENG, Shanghai (CN); Shih-Kuang TSAI, Shanghai (CN)

(21) Appl. No.: 14/945,409

(22) Filed: Nov. 18, 2015

(30) Foreign Application Priority Data
Mar. 24, 2015 (CN) 201510130334.5

(51) Int. Cl. B29C 67/00; G05B 19/4099

(52) U.S. Cl. CPC B29C 67/0088; B29C 67/0055; B29C 67/0085; G05B 19/4099; B29K 2105/0058

(57) ABSTRACT

The present disclosure provides a method of printing self-assembling multiple models and apparatus to proceed the method. The method includes doing an organic combination of a plurality of small-sized three dimension printing models within a printable size range of a three dimension printing machine, and then adopting the three dimension printing machine to print the organic combination of a plurality of small-sized three dimension printing models, after that disassembling the organic combination of the small-sized three dimension printing models into the small-sized three dimension printing models.

### CROSS-REFERENCE TO RELATED APPLICATION

This application claims the priority benefit of Chinese Application serial no. 201510130334.5 filed Mar. 24, 2015, the full disclosure of which is incorporated herein by reference.

### BACKGROUND

1. Field of Invention

The present disclosure relates to a 3D model printing method. More particularly, the present disclosure relates to a 3D model assembly printing method.

2. Description of Related Art

A three-dimensional (3D) printer is an equipment which can print out a real three-dimensional object. The three-dimensional object is formed through depositing materials layer by layer and accumulating the layers to fabricate the object. This is different from other typical fabrication processes, which utilizes material removal machining. 3D printing is an additive manufacturing (AM) technique whereby a three-dimensional object is created by continuously printing continuous physical layers and adding new layer over the previous accumulated layers. 3D printing manufacturing has advantages over other additive manufacturing techniques such as faster speed, lower cost and

Currently, a three-dimensional printer performs several steps when printing a three-dimensional object. Firstly, a contour data of the printed three-dimensional object is acquired to form a corresponding three-dimensional printing model. Then, according to the model, the three-dimensional printer manufactures a three-dimensional unit with default printing configurations.

Due to physical size limitations, three-dimensional printers are configured with print dimension limits. Therefore, in order to manufacture varying size three-dimensional units, the three-dimensional printers may be forced to adopt different printing strategies to meet different demands. For example, if a three-dimensional printing model exceeds a three-dimensional printer's print dimension limits, the model may be divided into multiple 3D sub-models in which each conforms within the print dimension limitation. Accordingly, 3D sub-units corresponding to the 3D sub-models may be printed and then assembled to form the desired three-dimensional unit.

When printing small-scale three-dimensional unit, a 3D printer may encounter various challenges, such as poor printing resolution which makes the printed unit texture rough, time and power-use inefficiency in printing small units, and unnecessary material wastage, etc. Also, to print small-scale unit, there may need to be some additional outer supporting structures to be printed to strengthen the printed small-scale unit, causing further time, energy and material wastages.

### SUMMARY

According to one aspect, the present disclosure provides a method for creating a 3D printable assembly model. The method includes providing 3D models; performing a contour analysis on each of the 3D models to obtain contour data respectively corresponding with the 3D models; performing iterative computations, based on the contour data, to obtain selected 3D models for use to create the 3D printable assembly model; and arranging and adjoining the selected 3D models to integrally form the 3D printable assembly model comprising dimensions printable by a 3D printer.

According to another aspect, the present disclosure provides a method for printing a 3D assembly unit. The method includes providing a 3D printer configured with predetermined printing dimensional limits; obtaining a 3D printable assembly model according to the aforesaid method for creating the 3D printable assembly model; and printing a 3D assembly unit using the 3D printable assembly model, in which the 3D assembly unit includes dimensions printable within the predetermined printing dimensional limits.

According to another aspect, the present disclosure provides a 3D printer having printable dimensional limits. The 3D printer includes a storage module, a processing module and a printing module. The storage module is configured to store 3D models for use in 3D printing. The processing module is configured to perform a contour analysis on each of the 3D models to obtain contour data respectively corresponding with the 3D models, to generate selected 3D models by performing iterative computations on the contour data, and to arrange and adjoin the selected 3D models to integrally form a 3D printable assembly model, in which the 3D printable assembly model is generated within the printable dimensional limits of the 3D printer. The printing module is configured to print a 3D assembly unit substantially according to the 3D printable assembly model.

It is to be understood that both the foregoing general description and the following detailed description are provided as examples, and are intended to provide further explanation of the invention as claimed.

The disclosure can be more fully understood by reading the following detailed description of the embodiments, with reference made to the accompanying drawings.

### BRIEF DESCRIPTION OF THE DRAWINGS

FIG. 1 is a flow chart of a method for creating a 3D printable assembly model and utilizing the 3D printable assembly model to print a 3D assembly unit according to an embodiment of the present disclosure.

FIG. 2 is a block diagram of a 3D printer according to an embodiment of the present disclosure.

FIGS. 3 and 4 are schematic cross-sectional views of 3D models according to an embodiment of the present disclosure.

FIG. 5 is a schematic cross-sectional view of a 3D printable assembly model comprising the 3D models shown in FIG. 3 and FIG. 4, according to an embodiment of the present disclosure.

FIG. 6 is a schematic representation of a 3D printer creating a 3D assembly unit from the 3D printable assembly model shown in FIG. 5, according to an embodiment of the present disclosure.

Corresponding numerals and symbols shown in the figures generally refer to corresponding parts unless otherwise indicated. The figures illustrate relevant aspects of the embodiments and are not necessarily drawn to scale.

### DETAILED DESCRIPTION

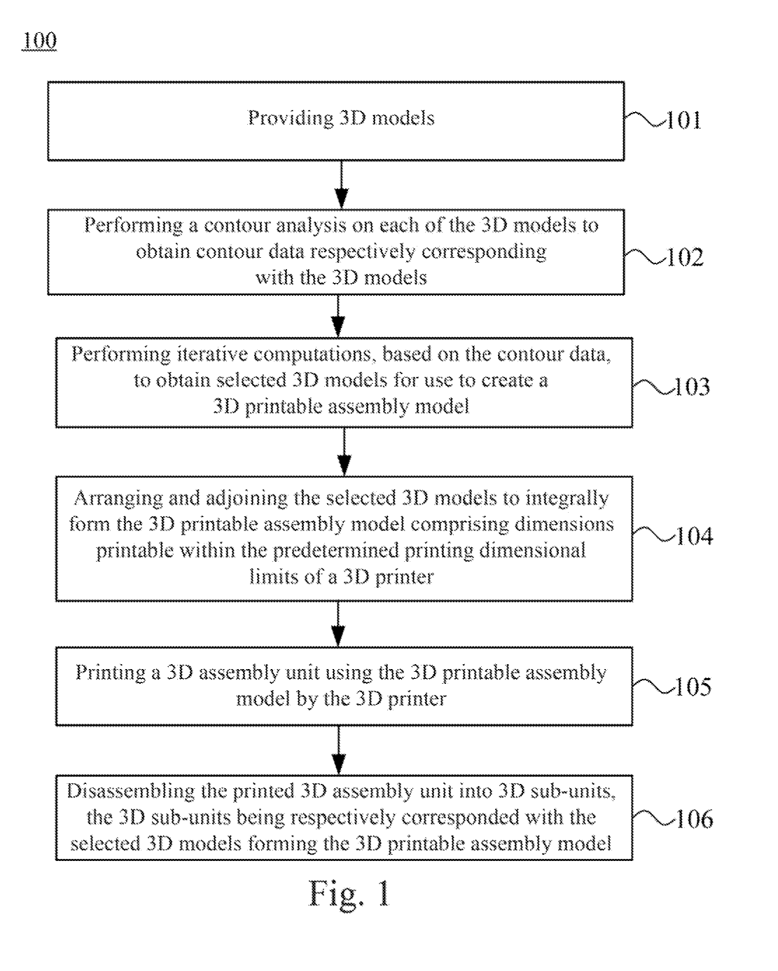

Referring to FIG. 1, a method 100 for creating a 3D printable assembly model and utilizing the 3D printable assembly model to print a 3D assembly unit is provided, which includes steps 101 to 106. In step 101, 3D models are provided or acquired by a 3D printer device performing said method. In step 102, a contour analysis is performed on each of the 3D models provided in step 101, to obtain contour data respectively corresponding with the 3D models. In some embodiments, the performing of the contour analysis may include computing dimensions of a contour of each of the 3D models, and computing a contour space located proximal to the contour. The dimensions of the contour described herein may represent, for example, width/depth/height dimensions of the contour. In some embodiments, the performing of the contour analysis may include creating a projected outline of each of the 3D models by contour projection, and measuring the projected outline. The projected outline may be created by projecting the outline of the 3D model onto three or more projected planes from different angles. In some embodiments, the projected outline may be created by projecting the outline of the 3D model onto three projected planes, which are mutually orthogonal to each other.

It should be noted that, the contour space described herein may include a space within the printing dimensional limits of the 3D printer not occupied by the computed 3D model, and the contour analysis may place the computed 3D model at various locations within the printing dimensional limits to compute the contour space. Therefore, the contour space may vary depending on the location of the computed 3D model placed inside the space created with the printing dimensional limits, so the computation of the contour space may be obtained by executing iterative computations, which is described in the following steps.

In step 103, iterative computations are performed based on the contour data, to obtain selected 3D models chosen from the plurality of 3D models provided in step 101. The selected 3D models are configured to be used to create a 3D printable assembly model. In some embodiments, the performing of the iterative computations may include determining whether any of the rest of the 3D models can be wholly placed within the contour space of the computed 3D model, and selecting the computed 3D model and the rest of the 3D model that can be wholly placed within the contour space. The selected 3D models are used to create the 3D printable assembly model.

It should be noted that, in some embodiments, the composition of the selected 3D models may vary depending on the computed 3D model and the contour space created by the computed model. That is, the selected 3D models described herein may not represent the only suitable combination. A configuration of selecting the selected 3D models among the 3D models to obtain the selected 3D models may be adjusted to the actual user requirements. For example, the selected 3D models may be selected from the 3D models to create a 3D printable assembly model occupying the most of the space within the contour space. For example, the selected 3D models may be selected from the 3D models to create a 3D printable assembly model by the 3D models being provided on-demand.

In some embodiments, the performing of the iterative computations may further include designating a part of the contour as an allowable region for adjoining the selected 3D model. The allowable region described herein may represent a region on a surface of the computed 3D model of which the corresponding contour space which can wholly accommodate the one or more selected 3D models. Alternatively, the allowable region described herein may represent a region on the surface of the computed 3D model for the computed 3D model to adjoin the rest of the selected 3D model. In step 104, the selected 3D models can be arranged and adjoined to integrally form a 3D printable assembly model whose dimensions are within the printable dimensional limits of the 3D printer. It should be noted that, the predetermined printing dimensional limits described herein may be different as different 3D printers, so the 3D printable assembly model may not represent a fixed combination, and would depend on different printing configurations.

In some embodiments, the arranging and adjoining of the selected 3D models may include determining a placement configuration of the selected 3D models. This may be done according to the contour data of the selected 3D models to compute a characteristic curve of each of the selected 3D models, and arranging the selected 3D models by matching the characteristic curves of the selected 3D models. In some embodiments, the placement configuration may include both a placement direction and a placement tilt angle of the selected 3D model. In some embodiments, the characteristic curve of each of the selected 3D models may be computed based on the contour data created in step 103, either being computed or projected. In some embodiments, a recognition and matching algorithm may be adopted to match the characteristic curves of the selected 3D models for arranging the selected 3D models into a 3D printable assembly model. The recognition and matching algorithm described herein may be executed to first recognize each of the selected 3D models, and the match the characteristic curves of the selected 3D models without overlapped area for arranging the selected 3D models into a 3D printable assembly model. Afterwards, adjoining the selected 3D models adjacent to each others in the 3D printable assembly model. In some embodiments, the arranging and the adjoining of the selected 3D models may fulfill a requirement that the dimensions or volume of the contour of the 3D printable assembly model are minimized, in order to save printing time, electricity and consumptive material.

In some embodiments, the arranging and adjoining of the selected 3D models may include adopting a connectivity judging algorithm on the 3D printable assembly model to determine whether the selected 3D models are mismatched or not, to ensure that the selected 3D models are arranged into the 3D printable assembly model without any overlapped area. For example, the connectivity judging algorithm may be executed to ensure that any of the selected 3D models in the 3D printable assembly model doesn't connect with each other, so that a 3D assembly unit based on the 3D printable assembly model can be printed without any overlapping area. Any overlapping area between two or more selected 3D models in the 3D printable assembly models is undesirable as it may also create overlapping area in the 3D assembly unit, which may ruin the 3D sub-units while performing disassembly of the 3D sub-units.

In some embodiments, the arranging and adjoining of the selected 3D models may further include forming joining support members located between the selected 3D models for connecting the selected 3D models. The joining support members may also provide the 3D sub-unit support before it is disassembled from the 3D assembly unit. In some embodiments, the shape of the joining support members may be a square, a rectangle, a diamond, a circle, an oval, a rhombus or other suitable shape. In some other embodiments, the printed 3D assembly unit may not have the joining support members among the 3D sub-units.

Thereafter, the 3D printable assembly model is utilized for printing the 3D assembly unit, described in detail as step 105 and step 106. In step 105, a 3D printer with the defined printable dimensional limits is provided. The 3D printer is configured to print the 3D assembly unit using the 3D printable assembly model. In step 106, the printed 3D assembly unit may be further disassembled into 3D sub-units, in which the 3D sub-units respectively correspond with the selected 3D models, which are joined to form the 3D printable assembly model. The disassembling of the 3D assembly unit may be executed by a cutter engaging the 3D assembly unit, such that the cutter is configured to directly separate or slice the 3D assembly unit into the 3D sub-units.

Accordingly, instead of needing to print the outer supporting structure, the computed 3D model and the rest of the selected 3D models can be supported by each other. The method 100 can create several 3D sub-units in a single printing process rather than multiple printing processes, and the consumption of time, electricity and consumptive material for printing the 3D models can be saved.

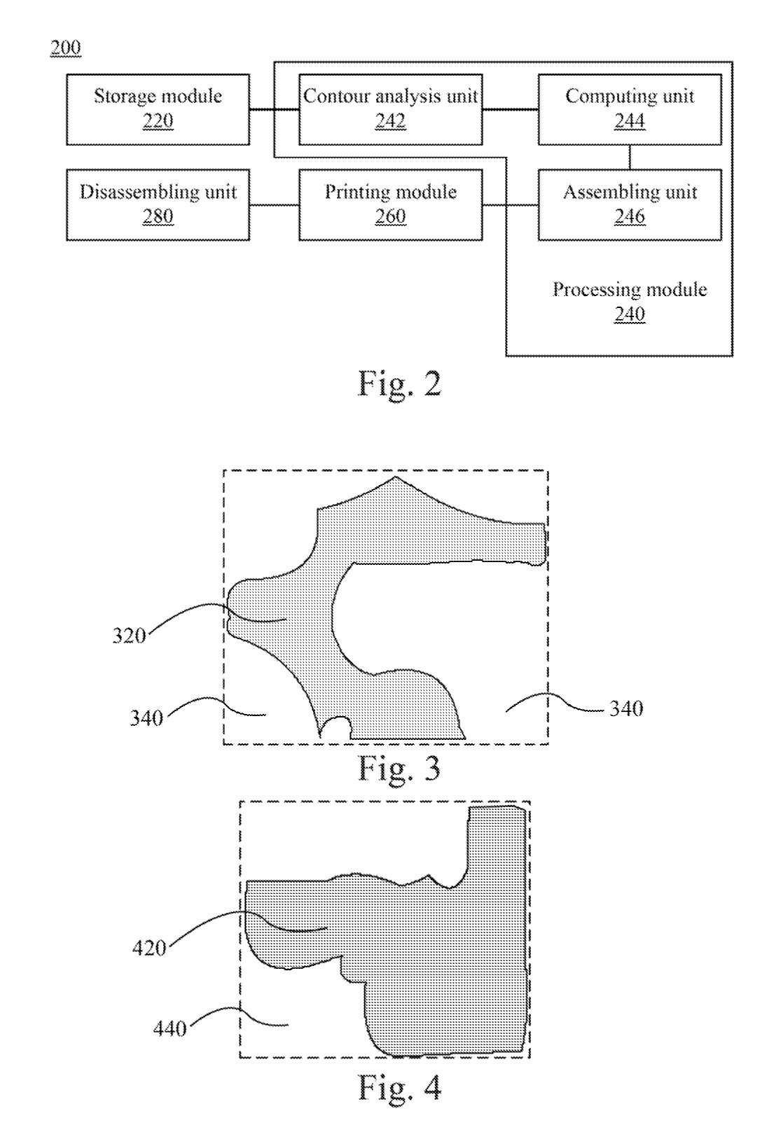

Referring to FIG. 2, a 3D printer 200 according to an embodiment of the present disclosure is provided. The 3D printer 200 has printable dimensional limits and includes a storage module 220, a processing module 240 and a printing module 260. In an alternative embodiment, the 3D printer 200 further includes a Disassembling unit 280. The storage module 220 is configured to store 3D models for use in 3D printing. In some embodiments, the 3D models can be acquired from an acquisition module (not shown), which scans physical objects and constructs 3D models of the scanned physical object. In some embodiments, the 3D models can be acquired from other devices, for example, from interconnected remote devices or from cloud servers. In some embodiments, the processing module 240 may include a contour analysis unit 242, a computing unit 244, and an assembling unit 246. In some embodiments, the contour analysis unit 242 may be configured to perform a contour analysis on each of the 3D models to obtain a contour data respectively corresponding with the 3D models. In some embodiments, the computing unit 244 may be configured to generate the selected 3D models by performing the iterative computations on the contour data. In some embodiments, the assembling unit 246 may be configured to arrange and adjoin the one or more selected 3D models to integrally form a 3D printable assembly model. The printing module 260 is configured to print a 3D assembly unit substantially according to the 3D printable assembly model.

In some embodiments, the assembling unit 246 may also be configured to adopt the contour data of the selected 3D models to compute characteristic curves for arranging the selected 3D models by matching the characteristic curves. In some embodiments, the assembling unit 246 may also be configured to adopt a connectivity judging algorithm on the 3D printable assembly model to determine if the selected 3D models are matched or mismatched.

In some embodiments, the processing module 240 may also be configured to generate at least one joining support member among the selected 3D models in the 3D printable assembly model to adjoin the adjacent selected 3D models.

In some embodiments, the 3D printer 200 may further include a disassembling unit 280 configured to disassemble the 3D assembly unit into 3D sub-units, in which the 3D sub-units are corresponded with the selected 3D models forming the 3D printable assembly model. In some embodiments, the disassembling unit 280 may include a cutter, and the cutter can be configured to disengage the 3D assembly unit, to separate the 3D assembly unit into the 3D sub-units.

Referring to FIG. 3 and FIG. 4, a dashed-line frame surrounding a first 3D model 320 and a second 3D model 420 represents printing dimension limits of a 3D printer capable of printing out the first 3D model 320 and the second 3D model 420. In prior art operation, to print the first and second 3D models 320, 420 separately, the 3D printer needs to print each with additional outer supporting structures. For example, the 3D printer prints outer supporting structures 340 in order to support the printed first 3D model 320 during the printing process. Otherwise, the printed first 3D model 320 may be tilted during the printing process due to an imbalance of force exerted on the printed 3D model 320. The tilted printed first 3D model 320 during the printing process may cause deviation of the printed first 3D model 320, and the deviation of the printed first 3D model 320 may result in the 3D printer continuously printing onto an incorrect position relative to the printed first 3D model 320. Similarly, prior art processes of printing out the second 3D model 420 by a 3D printer would also need to include printing out some additional outer supporting structures, such as an outer supporting structure 440.

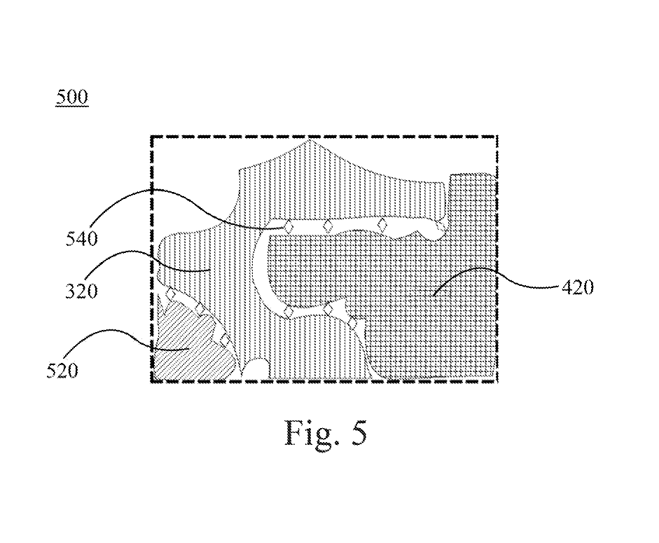

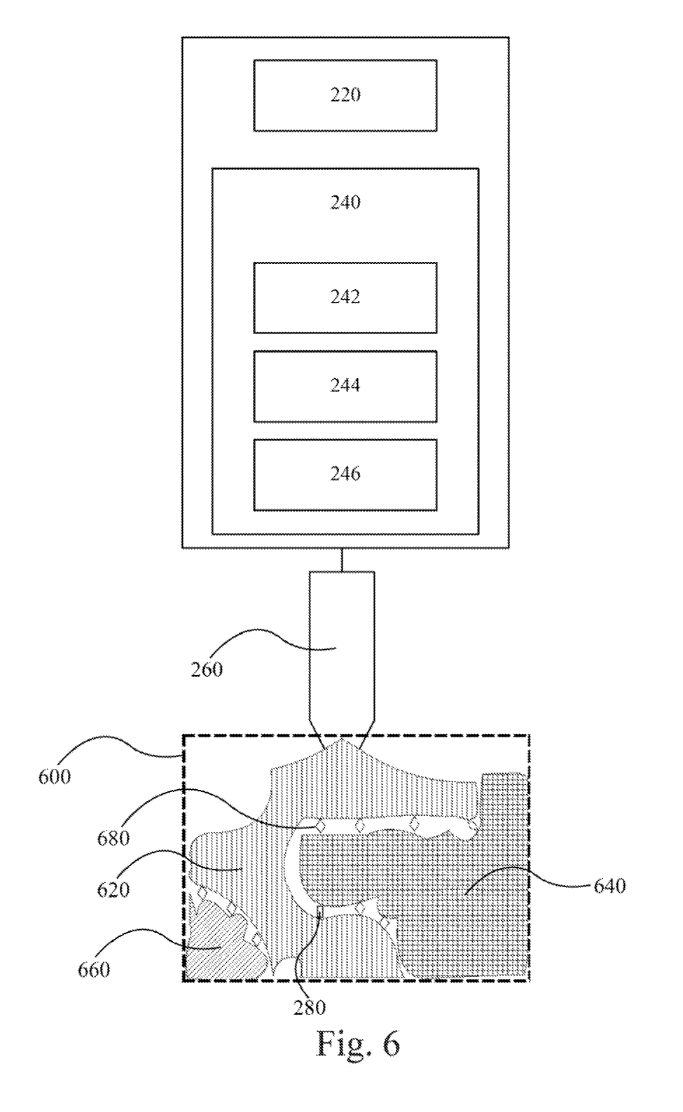

Referring to FIG. 6, the 3D printer 200 is configured to print out the first 3D model 320 to create a first 3D sub-unit 620; print out the second 3D model 420 to create a second 3D sub-unit 640; and print out a third 3D model 520 (shown in FIG. 5) to create a third 3D sub-unit 660. Firstly, the contour analysis unit 242 of the processing module 240 performs a contour analysis on each of the first, second, and third 3D models 320, 420, 520, to obtain corresponding contour data of each of the 3D models. Subsequently, the computing unit 244 performs iterative computations to generate the selected 3D models based on the contour data. The first, second, and third 3D models 320, 420, 520 are selected as they can be assembled within the predetermined printing dimensional limits (see FIG. 5). Thereafter, the assembling unit 246 of the processing unit 240 adopts the contour data of the first, second, and third 3D models 320, 420, 520 to compute characteristic curves, and then arranges and adjoins them by matching the characteristic curves into the 3D printable assembly model 500, as shown in FIG. 5. In some embodiments, the matching of the characteristic curves described herein may be executed as matching puzzles in two dimensions. Therefore, as illustrated in FIG. 5, a 3D printable assembly model 500 can be generated by combining the first, second, and third 3D models 320, 420, 520.

Referring back to the FIG. 6, the printing module 260 can print out a 3D assembly unit 600 layer by layer, in which the 3D assembly unit 600 is printed substantially according to the 3D printable assembly model 500, and within the printing dimensional limits shown in dashed-line frame in FIG. 5. The 3D sub-units of the 3D assembly unit 600, such as the first 3D sub-unit 620, the second 3D sub-unit 640, and the third 3D sub-unit 660, correspond to the first 3D models 320, the second 3D model 420, and the third 3D model 520 respectively. The 3D sub-units 620, 640, 660 are printed in a single printing process, instead of printing each out individually.

In some embodiment, the assembling unit 246 may adopt the connectivity judging algorithm on the 3D printable assembly model 500 to determine if the 3D models 320, 420, 520 are mismatched, or to ensure that they are arranged into the 3D printable assembly model 500 without any overlapping area.

In some embodiments, the processing module 240 may generate joining support members 540 to adjoin the adjacent selected 3D models, as shown in FIG. 5. Then, the 3D printable assembly model 500 with the joining support members 540 can be printed out to construct a 3D assembly unit 600 with the joining support members 680.

It will be readily understood by those skilled in the art that changes, substitutions, and alterations can be made to the embodiments without departing from the spirit and scope of the disclosure. Features, functions, processes, materials, machines, fabricate, means, methods, or steps, presently existing or later to be developed, that perform substantially the same function or achieve substantially the same result as the corresponding embodiments described herein may be utilized according to the present disclosure.

What is claimed is:

1. A method for creating a 3D printable assembly model, comprising the following steps:
providing a plurality of 3D models;
performing a contour analysis on each of the 3D models to obtain a plurality of contour data respectively corresponding with the 3D models;
performing iterative computations, based on the contour data, to obtain a plurality of selected 3D models for use to create the 3D printable assembly model; and
arranging and adjoining the selected 3D models to integrally form the 3D printable assembly model comprising dimensions printable by a 3D printer.

2. The method of claim 1, wherein the performing of the contour analysis comprises:
computing Width/Depth/Height dimensions of a contour of each of the 3D models; and
computing a contour space located proximal to the contour.

3. The method of claim 2, wherein the performing of the iterative computations comprises:
determining if the rest of the 3D models can be wholly placed within the contour space of the computed 3D model; and
selecting the rest of the 3D model that can be wholly placed within the contour space and the computed 3D model as the selected 3D models for use to create the 3D printable assembly model.

4. The method of claim 3, wherein after the performing of the iterative computations, the method further comprises:
designating a part of the contour as an allowable region for adjoining the selected 3D model.

5. The method of claim 1, wherein the performing of the contour analysis comprises:
creating a projected outline of each of the 3D models by contour projection; and
measuring the projected outline.

6. The method of claim 1, wherein the arranging and adjoining of the selected 3D models comprises:
determining a placement configuration of the selected 3D models;
computing a characteristic curve of each of the selected 3D models, based on the contour data of the selected 3D models; and
arranging the selected 3D models by matching the characteristic curves of the selected 3D models.

7. The method of claim 6, wherein the arranging and adjoining of the selected 3D models further comprises:
adopting a connectivity judging algorithm on the 3D printable assembly model to determine whether the selected 3D models are mismatched.

8. The method of claim 1, wherein the arranging and adjoining of the selected 3D models further comprises:
forming a joining support member located between and connecting the selected 3D models.

9. The method of claim 8, wherein the joining support member comprises a shape configuration resembling a square, a rectangle, a diamond, a circle, an oval, or a rhombus.

10. A method for printing a 3D assembly unit, comprising:
providing a 3D printer configured with predetermined printing dimensional limits;
obtaining a 3D printable assembly model according to the method of claim 1; and
printing a 3D assembly unit using the 3D printable assembly model, the 3D assembly unit comprising dimensions printable within the predetermined printing dimensional limits.

11. The method of claim 10, further including:
disassembling the printed 3D assembly unit into a plurality of 3D sub-units, the 3D sub-units being respectively corresponded with the selected 3D models forming the 3D printable assembly model.

12. A 3D printer having printable dimensional limits, the 3D printer comprising:
a storage module configured to store a plurality of 3D models for use in 3D printing;
a processing module configured to perform a contour analysis on each of the 3D models to obtain a plurality of contour data respectively corresponding with the 3D models, to generate a plurality of selected 3D models by performing iterative computations on the contour data, and to arrange and adjoin the selected 3D models to integrally form a 3D printable assembly model, wherein the 3D printable assembly model is generated within the printable dimensional limits; and
a printing module configured to print a 3D assembly unit substantially according to the 3D printable assembly model.

13. The 3D printer of claim 12, wherein the processing module comprises a contour analysis unit configured to perform the contour analysis on each of the 3D models to obtain the contour data respectively corresponding with the 3D models.

14. The 3D printer of claim 12, wherein the processing module comprises a computing unit configured to generate the selected 3D models by performing the iterative computations on the contour data.

15. The 3D printer of claim 12, wherein the processing module comprises an assembling unit configured to arrange and adjoin the one or more selected 3D models to integrally form the 3D printable assembly model.

16. The 3D printer of claim 15, wherein the assembling unit is further configured to adopt the contour data of the selected 3D models to compute a plurality of characteristic curves for arranging the selected 3D models by matching the characteristic curves.

17. The 3D printer of claim 16, wherein the assembling unit is further configured to adopt a connectivity judging algorithm on the 3D printable assembly model to determine whether the selected 3D models are mismatched.

18. The 3D printer of claim 12, wherein the processing module is further configured to generate at least one joining support member to adjoin the selected 3D models.

19. The 3D printer of claim 12, further comprising a disassembling module configured to disassemble the 3D assembly unit into a plurality of 3D sub-units, the 3D sub-units being corresponded with the selected 3D models forming the 3D printable assembly model.

20. The 3D printer of claim 19, wherein the disassembling module comprises a cutter configured to engage the 3D assembly unit, so as to separate the 3D assembly unit into the 3D sub-units.
